(19) United States
(12) Patent Application Publication
(10) Pub. No.: US 2017/0213548 A1
(43) Pub. Date: Jul. 27, 2017

(54) SCORE STABILIZATION FOR SPEECH CLASSIFICATION

(71) Applicant: INTERNATIONAL BUSINESS MACHINES CORPORATION, Armonk, NY (US)

(72) Inventor: HAGAI ARONOWITZ, NPetah-Tikva (IL)

(21) Appl. No.: 15/002,438

(22) Filed: Jan. 21, 2016

(51) Int. Cl. G10L 15/14; G10L 15/06

(52) U.S. Cl. CPC G10L 15/14; G10L 15/063

(57) ABSTRACT

A method for stabilizing speaker recognition scores, comprising using one or more hardware processors for the following actions: Receiving supervectors from a Gaussian Mixture model analysis performed by a speaker recognition system, where the supervectors represent speech signals acquired by a microphone. Performing a principal component analysis of a covariance matrix of the supervectors, thereby producing eigenvalues and eigenvectors of the covariance matrix. Removing some of the eigenvectors associated with a number of highest value eigenvalues from the supervectors, thereby producing stabilized supervectors. Sending the stabilized supervectors to the speaker recognition system to compute stabilized speaker recognition scores.

### BACKGROUND

The invention relates to the field of speech signals and speaker recognition.

Speaker recognition systems process speech signals obtain from one or more microphones to identify the speakers of each speech signal. Enrollment session data, such as speech signals with known speakers, of both text-independent and text-dependent tasks are used to build speaker models, and the speaker models are compared to verification session speech signals to recognize the speaker. Usually, a large amount of training speech signals is needed for building an accurate model for each speaker.

In speaker recognition systems using a Gaussian Mixture Models (GMM), a Nuisance Attribute Projection (NAP) framework may be adapted for speech signals from different sessions, such as enrollment, verification and development sessions and the like. A Universal Background Model (UBM) may be used to estimate a NAP projection from the enrollment data, which may be used to compensate intra-speaker and/or inter-session variability, such as channel variability.

An energy-based voice activity detector may be used to locate and remove non-speech frames. Mel-frequency cepstral coefficients (MFCC) and derivatives may be computed to estimate speech signal coefficients. For example, each speech signal feature set may consist of 12 cepstral coefficients augmented by 12 delta and 12 double-delta coefficients extracted every 10 milliseconds using a 25 millisecond window. Feature warping may be applied with a 300 frame window before computing the delta and double-delta features.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for stabilizing speaker recognition scores, comprising using one or more hardware processors for the following actions. The method comprises an action of receiving supervectors from a Gaussian Mixture model analysis performed by a speaker recognition system, where the supervectors represent speech signals acquired by a microphone. The method comprises an action of performing a principal component analysis of a covariance matrix of the supervectors, thereby producing eigenvalues and eigenvectors of the covariance matrix. The method comprises an action of removing some of the eigenvectors associated with a number of highest value eigenvalues from the supervectors, thereby producing stabilized supervectors. The method comprises an action of sending the stabilized supervectors to the speaker recognition system to compute stabilized speaker recognition scores.

Optionally, the eigenvalue removing is performed using the projection computed from the equation P=I−VV^{t} where V denotes a matrix created by stacking some of the eigenvectors and I denotes the identity matrix.

Optionally, the number of highest value eigenvalues is predefined number.

Optionally, the number of highest value eigenvalues is automatically computed by iteratively removing eigenvectors according to the highest unremoved eigenvalue, until a threshold value of a speaker score difference is reached, where the speaker score difference is the absolute value of the difference between a known-speaker score and an imposter score.

Optionally, the stabilized speaker recognition scores are normalized by compensating for score variations between speech signals.

Optionally, the stabilized speaker recognition scores are normalized by setting the mean of the stabilized speaker recognition scores to a value of zero and the variance of the stabilized speaker recognition scores to a value of one.

Optionally, the removing comprises a transformation of the supervectors to remove the variation of the supervectors associated with the corresponding eigenvectors.

There is provided, in accordance with an embodiment, a computer program product for stabilizing speaker recognition scores, the computer program product comprising a non-transitory computer-readable storage medium having program code embodied therewith, the program code executable by hardware processor(s). The program code comprises processor instruction to receive supervectors from a Gaussian Mixture model analysis performed by a speaker recognition system, where the supervectors represent speech signals acquired by a microphone. The program code comprises processor instruction to perform a principal component analysis of a covariance matrix of the supervectors, thereby producing eigenvalues and eigenvectors of the covariance matrix. The program code comprises processor instruction to remove the eigenvectors of a number of highest value eigenvalues from the supervectors, thereby producing stabilized supervectors. The program code comprises processor instruction to send the stabilized supervectors to the speaker recognition system to compute stabilized speaker recognition scores.

Optionally, the number of highest value eigenvalues is predefined number.

Optionally, the number of highest value eigenvalues is automatically computed by iteratively removing eigenvectors according to the highest unremoved eigenvalue, until a threshold value of a speaker score difference is reached, where the speaker score difference is the absolute value of the difference between a known-speaker score and an imposter score.

Optionally, the stabilized speaker recognition scores are normalized by compensating for score variations between speech signals.

Optionally, the stabilized speaker recognition scores are normalized by setting the mean of the stabilized speaker recognition scores to a value of zero and the variance of the stabilized speaker recognition scores to a value of one.

Optionally, the removing comprises a transformation of the supervectors to remove the variation of the supervectors associated with the corresponding eigenvectors.

There is provided, in accordance with an embodiment, a computerized system for stabilizing speaker recognition scores. The computerized system comprises a non-transitory computer-readable storage medium having stored thereon program code. The program code comprises processor instruction to receive supervectors using the network adapter from a Gaussian Mixture model analysis performed on a speaker recognition system, where the supervectors represent speech signals acquired by a microphone, program code comprises processor instruction to perform a principal component analysis of a covariance matrix of the supervectors, thereby producing eigenvalues and eigenvectors of the covariance matrix. The program code comprises processor instruction to remove the eigenvectors of a number of highest value eigenvalues from the supervectors, thereby producing stabilized supervectors. The program code comprises processor instruction to send the stabilized supervectors using the network adapter to the speaker recognition system to compute stabilized speaker recognition scores. The computerized system comprises one or more hardware processors configured to execute the program code.

Optionally, the number of highest value eigenvalues is predefined number.

Optionally, the number of highest value eigenvalues is automatically computed by iteratively removing eigenvectors according to the highest unremoved eigenvalue, until a threshold value of a speaker score difference is reached, where the speaker score difference is the absolute value of the difference between a known-speaker score and an imposter score.

Optionally, the stabilized speaker recognition scores are normalized by compensating for score variations between speech signals.

Optionally, the stabilized speaker recognition scores are normalized by setting the mean of the stabilized speaker recognition scores to a value of zero and the variance of the stabilized speaker recognition scores to a value of one.

Optionally, the removing comprises a transformation of the supervectors to remove the variation of the supervectors associated with the corresponding eigenvectors.

Optionally, the computerized system comprises the speaker recognition system.

In addition to the exemplary aspects and embodiments described above, further aspects and embodiments will become apparent by reference to the FIGS. and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a schematic illustration of a system for speaker recognition score stabilization, according to some embodiments of the present invention; and

FIG. 2 is a flowchart of a method for speaker recognition score stabilization, according to some embodiments of the present invention.

### DETAILED DESCRIPTION

According to some embodiments of the present invention, there are provided systems and methods for automatically stabilizing scores in speaker recognition systems.

According to some embodiments, a speaker recognition system that uses a Gaussian Mixture Model (GMM) for analysis of enrollment data, sends supervectors of multiple speech signal parameters to a hardware processor of the system. The covariance matrix for the enrollment data supervectors is analyzed by Principal Component Analysis (PCA), and the eigenvectors of the top eigenvalues are removed from the supervectors to stabilize scores produced from the enrollment data, optionally normalized. The stabilized supervectors are returned to a speaker recognition system to be processed for speaker recognition, such as by using a NAP framework and UBM processing.

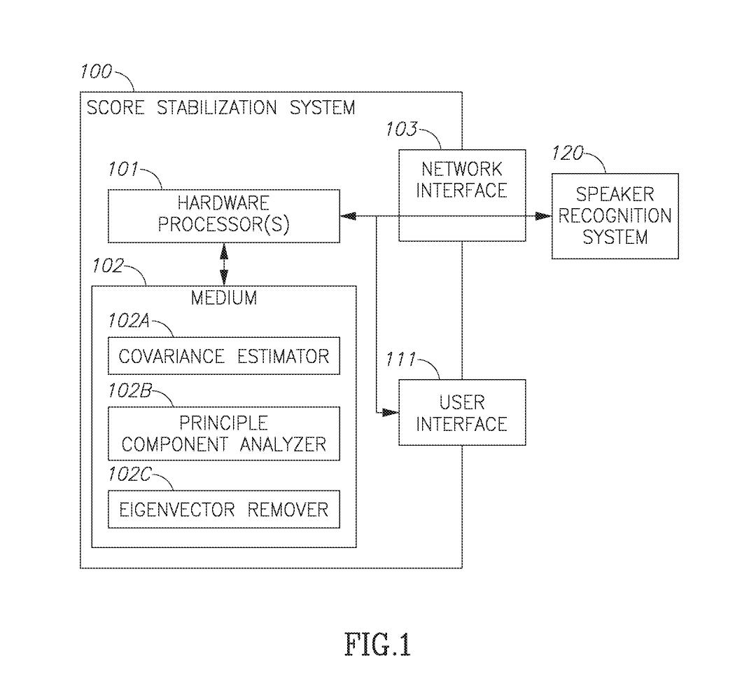

Reference is now made to FIG. 1, which is a schematic illustration of a system 100 for speaker recognition score stabilization, according to some embodiments of the present invention. One or more hardware processors 101 of score stabilization system 100 receive supervectors from a speaker recognition system 120 through a network interface 103. Hardware processor(s) 101 execute processor instructions stored on a storage medium 102.

A covariance estimator 102A contains processor instructions that when executed on hardware processor(s) 101 determine the covariance matrix of the supervector data. A principal component analyzer 102B contains processor instructions that when executed on hardware processor(s) 101 determine the eigenvalues and eigenvectors of the covariance matrix. An eigenvector remover 102C contains processor instructions that when executed on hardware processor(s) 101 remove the influence of some of the eigenvectors from the supervector data, such as flattening the supervector data to remove the variance associated with the subset of eigenvectors. Optionally, system 100 operation is controlled by a user through a graphical user interface 111.

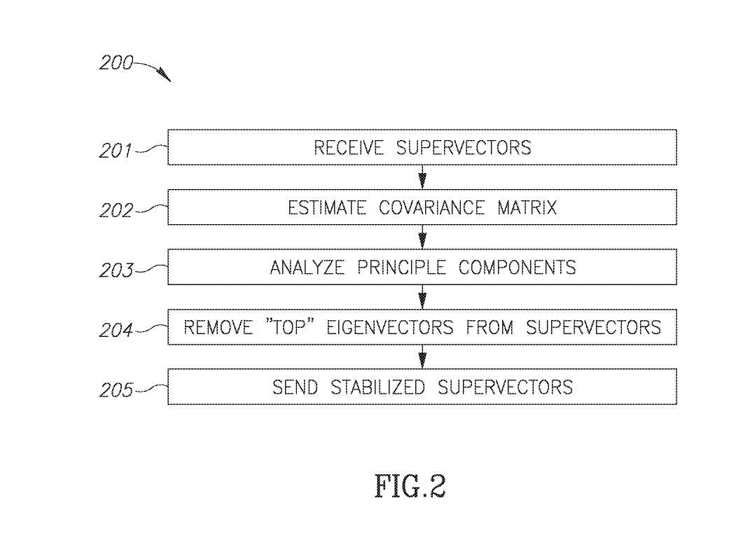

Reference is now made to FIG. 2, which is a flowchart of a method 200 for speaker recognition score stabilization, according to some embodiments of the present invention. Method 200 comprises an action of automatically using customized hardware processor(s) 101 for receiving 201 supervectors from a speaker recognition system 120. Hardware processor(s) 101 automatically perform an action of estimating 202 the covariance matrix of the enrollment data supervectors. Hardware processor(s) 101 automatically perform an action of analyzing 203 the principal components of the covariance matrix. Hardware processor(s) 101 automatically perform the action of removing 204 a number of eigenvectors corresponding to the highest eigenvalues from the supervectors, producing stabilized supervectors. Hardware processor(s) 101 automatically perform an action of sending 205 the stabilized supervectors to speaker recognition system 120.

Optionally, the number of eigenvectors to remove in action 204 from the supervectors is a predetermined number. For example, 10 eigenvectors are removed from the supervectors. For example, 25 eigenvectors are removed from the supervectors. For example, 50 eigenvectors are removed from the supervectors. For example, the number of eigenvectors to remove from the supervectors is between 5 and 100.

Optionally, the number of eigenvectors removed in action 204 from the supervector data is iteratively determined by comparing one or more normalized score(s) of the GMM model computed between the speaker model and supervectors of a known recognized speaker and a known imposter after removal of each eigenvector. The score difference between the speaker and the imposter, for example, is computed during each iteration. The eigenvectors are ordered according to the decreasing eigenvalues, and iteratively removed from the supervector data. After each removal iteration, the speaker model is recomputed. The recomputed speaker model is used to compute differences in the normalized scores between the speaker and imposter supervectors to determine if the removal of the eigenvector improved the score difference. When the normalized score difference begins to decrease, the hardware processor records the number of eigenvectors from the previous iteration as the optimal number of eigenvectors to remove from the supervectors for speaker recognition. Hardware processor(s) 101 sends stabilized 205 supervectors after removal 204 of this number of eigenvectors to speaker recognition system 120. Following are example computations of the supervectors, covariance matrix, principal components, and stabilized normalization scores.

For example, a 512-Gaussian UBM with diagonal covariance matrices may be applied to the enrollment data for extracting supervectors. The means of the GMMs are stacked into a supervector, denoted s, after normalization with the corresponding standard deviations of the UBM and multiplication by the square root of the corresponding weight from the UBM:

S=Σ^{-1/2}(λ_{UBM}^{1/2} [symbol] I_{F})μ EQN. 1

where μ denotes the concatenated GMM means, λ_{UBM} denotes the vectorized UBM weights, Σ denotes a block diagonal matrix with covariance matrices from the UBM on its diagonal, F denotes the feature vector dimension, [symbol] denotes the Kronecker product, and h denotes the identity matrix of rank F.

For example, a low rank NAP projection, denoted P, may be estimated by removing from each supervector in the enrollment data the corresponding speaker supervector mean. The resulting supervectors may be named nuisance supervectors. The covariance matrix of the nuisance supervectors is computed and Principal Component Analysis (PCA) is applied to find a basis of the nuisance supervectors space. Projection P is created by stacking the top k eigenvectors as columns in matrix V:

P=I−VV^{t} EQN. 2

The enrollment data supervectors are compensated by applying projection P. For example, Ps is the projection of an enrollment supervector denoted s, Px is a projection of a verification supervector x, and/or the like. There may be no need to project the verification data supervectors when dot-product scoring is used:

Score=(Ps)^{t}(Px)=s^{t}P^{t}Px32 (Ps)^{t}x EQN. 3

Scoring may be performed using a dot-product between the enrollment supervectors and the verification supervectors. The supervectors may be normalized prior to the scoring. For example, zero normalization (Z-norm) may compensate for inter-speaker score variation. Z-norm normalization may allow using a global, speaker-independent decision threshold. For example, test normalization (T-norm) may compensate for inter-session score variation. T-Norm may reduce the overlap between imposter and true score distributions of each speaker. ZT-score normalization may be used to normalize the enrollment data, by first applying Z-norm then T-norm. For example, a raw scoring function between an enrollment supervector denoted s and a verification supervector denoted x may be ZT-normalized to standardize the distribution of φ(s,x). For example, the Z-norm method estimates the mean and variance of φ(s,*) and uses them to standardize cp(s,*).

$${ϕ}_{Znorm} ( s , x ) = \frac{ϕ ( s , x ) - {μ}_{Z} ( s , \cdot )}{{σ}_{Z} ( s , \cdot )} \\ {μ}_{Z} ( s , \cdot ) = {E}_{{x}^{′}} ϕ ( s , {x}^{′} ) \\ {σ}_{Z} ( s , \cdot ) = \sqrt{{Var}_{{x}^{′}} ϕ ( s , {x}^{′} )} \qquad EQN . 4$$

Equivalent descriptions for T-norm and ZT-norm may be used for score normalization.

For example, given development data of n sessions with the corresponding supervectors X={x₁, . . . , xₙ}. Unbiased estimates for Z-norm parameters may be:

$${\hat{μ}}_{Z} ( s , X ) = {〈 ϕ ( s , x ) 〉}_{x ∈ X} \\ {\hat{σ}}_{Z}^{2} ( s , X ) = \frac{n}{n - 1} ( {〈 {ϕ}^{2} ( s , x ) 〉}_{x ∈ X} - {〈 ϕ ( s , x ) 〉}_{x ∈ X}^{2} ) \qquad EQN . 5$$

The normalized scores may be stabilized by minimizing the expected variances of \hat{μ}_{z}(s, X)/\hat{σ}_{z}(s, X) and \hat{∝}_{z}(s, X) over the distributions of X and s.

Without loss of generality the mean of the supervector population may be assumed 0 and that the covariance matrix of the supervector population is diagonal with its eigenvalues {λᵢ} on its diagonal. Assuming that impostor scores for a speaker s are independently drawn from a normal distribution, the variance of \hat{σ}_{z}(s, X) with respect to development data X may be computed using:

$${Var}_{X} ( {\hat{σ}}_{Z}^{2} ( s , X ) ) = \frac{2 {σ}_{Z}^{4} ( s , \cdot )}{n - 1} = \frac{2}{n - 1} {( {s}^{t} Cov ( x ) s )}^{2} \qquad EQN . 6$$

and the expected variance (with respect to s) may be computed using:

$${E}_{s} ( {Var}_{X} ( {\hat{σ}}_{Z}^{2} ( s , X ) ) ) = \frac{2}{n - 1} tr ( {Cov ( x )}^{4} ) \qquad EQN . 7$$

In order to minimize the expected variance of \hat{σ}_{z}(s, X) a low dimensional subspace spanning the top eigenvectors of Cov(x), which is the total variability covariance matrix, may be removed from the supervector space. Assuming that \hat{σ}_{z}(s,X) has already been stabilized using EQN. 6 and EQN. 7, \hat{μ}_{z}(s,X)/\hat{σ}_{z}(s,X) can be approximated with \hat{μ}_{z}(s,X)/σ_{z}(s,*):

$${Var}_{X} ( \frac{{\hat{μ}}_{Z} ( s , X )}{{σ}_{Z} ( s , \cdot )} ) = \frac{\frac{1}{n} {s}^{t} Cov ( x ) s}{{σ}_{z}^{2} ( s , \cdot )} = \frac{1}{n} \qquad EQN . 8$$

A low dimensional subspace in the high-level vector space, such as a supervector space, an i-vector space, and the like, which upon removal decreases substantially the expected variance of the score normalization parameters. For example, in the case of dot-product scoring the optimal subspace to be removed is spanned by the eigenvectors of the top eigenvalues of the total variability covariance matrix.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principals of the embodiments, the practical application or technical improvement over technologies found in the marketplace, or to enable others of ordinary skill in the art to understand the embodiments disclosed herein.

### EXPERIMENTAL RESULTS

The following are numerical examples of applying embodiments of the present invention to speech signal data. These numerical examples were tested experimentally.

The full datasets and reduced subsets are described for two dataset experiments, denoted as TD and TI experiments.

The TD experiment uses the WF dataset consisting of 750 speakers which are partitioned into an enrollment dataset of 200 speakers and a verification dataset of 550 speakers. Each speaker has 2 speech signal sessions recorded from a landline phone and 2 sessions recorded from a cellular phone. The WF dataset collection was accomplished over a period of 4 weeks.

Four authentication conditions were defined and collected: global, speaker-dependent, prompted passphrases, and free text. The global passphrase is shared among all speakers and the same passphrase is used for both development, enrollment and verification. A 10-digit passphrase of 0-1-2-3-4-5-6-7-8-9 are denoted ZN. In the WF dataset, each session contains 3 repetitions of ZN. For each enrollment session all 3 repetitions may be used as enrollment data, and for each verification session only a single repetition may be used.

The TI experiment uses the National Institute of Standards and Technology (NIST) 2010 Speaker Recognition Evaluation (SRE) dataset male core trial list with telephone conditions 5, 6 and 8. The dataset consists of 355, 178 and 119 target trials and 13746, 12825 and 10997 impostor trials respectively. The development dataset consists of male sessions from NIST 2004 and 2006 SREs telephone data. In total 4374 sessions from 521 speakers are used.

For the TD experiment, the WF data subsets are defined in TABLE 1. In TABLE 1, L indicates a landline sessions and C indicates a cellular session. For example, LLCC stands for 4 sessions, 2 landline sessions and 2 cellular sessions, and LC stands for 2 sessions, 1 landline session and 1 cellular session. Except for the last row of TABLE 1, indicated by 30RR, subsets are gender balanced. The last row describes a subset for which the genders are highly imbalanced, and the two sessions per speaker are selected randomly. The purpose of the 30RR subset may simulate a realistic condition when the actual data collected in not balanced as planned.

TABLE 1

| Name | Number of speakers | Sessions per speaker |
|---|---|---|
| Full | 200 | LLCC |
| 50 | 50 | LLCC |
| 50LC | 50 | LC |
| 30 | 30 | LLCC |
| 30LC | 30 | LC |
| 30LL | 30 | LL |
| 30CC | 30 | CC |
| 20 | 20 | LLCC |
| 20LC | 20 | LC |
| 30RR | 30 | RR |

In the TI experiment development data subsets, the number of speakers is varied between 20 and 500 in steps. Two different TI subsets were generated for every chosen number of speakers. The first TI subset consists of 2 sessions per speaker. The second TI subset consists of 4 sessions per speaker.

TABLE 2 shows results for the TD experiment using different subsets (along columns) for development. The baseline NAP system method is contrasted to an embodiment of the method and to score normalization with the full development dataset. Results are averaged over 10 randomly selected subsets. Best result for each subset in TABLE 2 are underlined for emphasis. Equal-error rate (EER) is also reported in TABLE 2.

TABLE 2

| System | 20LC | 20 | 30CC | 30LL | 30RR | 30LC | 30 | 50LC | 50 | Full |
|---|---|---|---|---|---|---|---|---|---|---|
| NAP 10 | 2.8 | 2.5 | 3.2 | 3.3 | 3.5 | 2.4 | 2.1 | 1.8 | 1.6 | 1.0 |
| NAP 10 SS 10 | 2.4 | 2.0 | 2.7 | 2.4 | 2.4 | 2.0 | 1.8 | 1.6 | 1.4 | 1.1 |
| NAP 10 SS 25 | 2.3 | 2.0 | 2.4 | 2.4 | 2.4 | 2.1 | 1.8 | 1.7 | 1.5 | 1.1 |
| NAP 10 SS 50 | 2.3 | 1.9 | 2.4 | 2.6 | 2.5 | 2.1 | 1.8 | 1.8 | 1.5 | 1.1 |
| NAP 10 Norm-full | 1.7 | 1.6 | 2.0 | 2.0 | 1.9 | 1.5 | 1.4 | 1.5 | 1.2 | 1.0 |
| EER reduction | 18% | 20% | 25% | 27% | 31% | 13% | 14% | 6% | 6% | −10% |
| (SS 25) | | | | | | | | | | |
| Recovery rate | 45% | 56% | 67% | 69% | 69% | 33% | 43% | 33% | 25% | — |
| (SS 25) | | | | | | | | | | |

TABLE 2 reports results for the TD experiment using different subsets (along columns) for development. The baseline system, such as with NAP subspace dimension of 10, is contrasted to an embodiment of the method. Subspace dimensions 10, 25 and 50 were used for score stabilization, indicated by SS. Results for score normalization with the full development set, but using a subset for NAP enrollment, are included to assess an extreme application. In order to reduce the variance of our measured EERs, each experiment is repeated 10 times with randomly selected subsets. For all subsets an embodiment of the method outperforms the baseline system, except for the full development data. The last two rows in TABLE 2 report the relative error reduction and the percentage of the error due to estimating the score normalization parameters on limited data that is recovered by an embodiment of the method.

TABLE 3 presents results for the TD experiment using different subsets for development. A Gaussian-based smoothing to a NAP system to better estimate the NAP-projection with limited data, and is contrasted to an embodiment of the method. Results are averaged over 10 randomly selected subsets. Best result for each subset in TABLE 3 are underlined for emphasis.

TABLE 3

| System | 20LC | 20 | 30CC | 30LL | 30RR | 30LC | 30 | 50LC | 50 | Full |
|---|---|---|---|---|---|---|---|---|---|---|
| GBS | 2.5 | 2.3 | 2.7 | 2.7 | 2.7 | 2.2 | 2.1 | 1.8 | 1.8 | 1.6 |
| GBS SS 10 | 2.1 | 2.0 | 2.2 | 2.1 | 2.1 | 1.9 | 1.8 | 1.7 | 1.6 | 1.3 |
| GBS SS 25 | 2.1 | 1.9 | 2.2 | 2.1 | 2.0 | 1.9 | 1.8 | 1.7 | 1.6 | 1.3 |
| GBS SS 50 | 2.1 | 1.8 | 2.2 | 2.3 | 2.4 | 1.9 | 1.7 | 1.7 | 1.6 | 1.4 |
| EER reduction | 16% | 17% | 19% | 22% | 26% | 14% | 14% | 6% | 11% | 19% |
| (SS 25) | | | | | | | | | | |

For all evaluated subsets, including full dataset, score stabilization improves accuracy.

TABLE 4 and TABLE 5 report results for the TI experiment using different subsets (along columns) of the development dataset. TABLE 4 reports results for two sessions per speaker, and TABLE 5 reports results for four sessions per speaker. Score stabilization, with a subspace dimension of 10, is evaluated on the baseline NAP method, with a subspace dimension of 100, and GBS-NAP, with a subspace dimension of 1000. In order to reduce the variance of our measured EERs, each experiment was repeated 10 times with different randomly selected subsets.

Note that for 108 experiments, score stabilization improves accuracy for 80 experiments and degraded accuracy in only 17, usually for 20 and 30 speakers.

TABLE 4 presents results for the TI experiment as a function of number of speakers in subset. Subsets contain two sessions per speaker. Results are averaged over 10 randomly selected subsets. Best result for each subset in TABLE 4 are underlined for emphasis.

TABLE 4

| Method | Cond. | 20 | 30 | 40 | 50 | 100 | 200 | 300 | 400 | 500 |
|---|---|---|---|---|---|---|---|---|---|---|
| NAP 100 | 5 | 13.7 | 13.2 | 11.8 | 10.7 | 9.6 | 7.3 | 6.2 | 5.4 | 5.4 |
| NAP + SS 10 | 5 | 13.7 | 13.0 | 11.0 | 10.1 | 8.7 | 6.5 | 5.6 | 4.5 | 5.1 |
| GBS | 5 | 12.7 | 11.8 | 9.3 | 8.5 | 8.6 | 8.5 | 8.7 | 8.5 | 8.5 |
| GBS + SS 10 | 5 | 12.9 | 11.5 | 9.6 | 8.8 | 8.2 | 7.6 | 6.8 | 6.4 | 6.8 |
| NAP-100 | 6 | 16.3 | 14.7 | 14.7 | 14.5 | 14.0 | 9.6 | 8.4 | 7.9 | 7.3 |
| NAP + SS 10 | 6 | 15.1 | 15.0 | 14.6 | 13.5 | 11.8 | 8.3 | 7.9 | 7.3 | 7.3 |
| GBS | 6 | 11.2 | 10.7 | 11.3 | 11.2 | 11.3 | 10.7 | 10.8 | 10.1 | 9.6 |
| GBS + SS 10 | 6 | 12.5 | 11.8 | 10.7 | 10.7 | 10.1 | 9.0 | 8.4 | 8.4 | 8.3 |
| NAP-100 | 8 | 6.7 | 5.9 | 5.0 | 5.0 | 4.2 | 2.5 | 1.7 | 1.5 | 1.7 |
| NAP + SS 10 | 8 | 6.7 | 6.7 | 4.2 | 4.1 | 1.7 | 1.7 | 1.7 | 1.7 | 1.7 |
| GBS | 8 | 5.2 | 4.0 | 3.5 | 3.4 | 3.5 | 3.5 | 3.4 | 3.4 | 3.4 |
| GBS + SS 10 | 8 | 5.8 | 4.2 | 3.4 | 3.4 | 3.4 | 2.6 | 2.5 | 2.5 | 2.5 |

TABLE 5 presents results for the TI experiment as a function of number of speakers in subset. Subsets contain four sessions per speaker. Results are averaged over 10 randomly selected subsets. Best result for each subset in TABLE 5 are underlined for emphasis.

TABLE 5

| Method | Cond. | 20 | 30 | 40 | 50 | 100 | 200 | 300 | 400 | 500 |
|---|---|---|---|---|---|---|---|---|---|---|
| NAP 100 | 5 | 12.4 | 12.1 | 10.5 | 9.0 | 7.0 | 4.8 | 4.4 | 3.9 | 3.9 |
| NAP + SS 10 | 5 | 12.4 | 11.5 | 9.5 | 9.3 | 6.5 | 4.8 | 4.2 | 3.9 | 3.9 |
| GBS | 5 | 12.4 | 10.4 | 9.6 | 9.3 | 9.3 | 9.2 | 9.2 | 9.2 | 9.2 |
| GBS + SS 10 | 5 | 11.3 | 10.4 | 9.3 | 9.0 | 7.9 | 7.0 | 6.7 | 6.5 | 6.5 |
| NAP-100 | 6 | 14.6 | 12.5 | 12.1 | 11.7 | 10.1 | 6.2 | 5.6 | 5.1 | 5.0 |
| NAP + SS 10 | 6 | 13.5 | 12.2 | 11.8 | 10.1 | 8.4 | 6.6 | 5.7 | 5.1 | 5.0 |
| GBS | 6 | 10.8 | 10.6 | 10.6 | 10.7 | 10.6 | 10.7 | 10.6 | 10.6 | 10.2 |
| GBS + SS 10 | 6 | 11.8 | 10.1 | 10.1 | 10.1 | 9.0 | 7.9 | 7.3 | 7.8 | 7.8 |
| NAP-100 | 8 | 5.1 | 4.3 | 3.5 | 3.4 | 2.3 | 1.0 | 1.0 | 0.8 | 0.8 |
| NAP + SS 10 | 8 | 4.3 | 4.0 | 3.3 | 2.5 | 1.6 | 1.6 | 1.0 | 1.0 | 1.0 |
| GBS | 8 | 5.2 | 4.2 | 4.2 | 4.2 | 4.1 | 4.5 | 4.2 | 4.2 | 4.2 |
| GBS + SS 10 | 8 | 5.8 | 5.0 | 4.2 | 4.1 | 3.4 | 2.6 | 2.5 | 2.5 | 2.5 |

The results in TABLE 2 and TABLE 3 show for the TD experiment, an average of approximately 50% of the error due to score normalization with limited data is recovered by the embodied method, approximately 20% relative error reduction. The results in TABLE 4 and TABLE 5 show for the TI experiment, the embodied method reduced error by 9% relative on average.

1. A method for stabilizing speaker recognition score normalization parameters, the method comprising using at least one hardware processor for:
applying Gaussian Mixture Model analysis to enrollment data acquired by a microphone of a computerized speaker recognition system, to obtain supervectors that are representative of multiple speech signal parameters contained in the enrollment data;
performing principal component analysis of a total variability covariance matrix of said supervectors, thereby producing eigenvalues and eigenvectors of said total variability covariance matrix;
removing some of the eigenvectors associated with a number of highest value eigenvalues from the supervectors, thereby producing stabilized supervectors; and
sending said stabilized supervectors to said computerized speaker recognition system;
computing by said computerized speaker recognition system, stabilized score normalization parameters; and
performing speaker recognition by said computerized speaker recognition systems, based on the score normalization parameters.

2. The method of claim 1, wherein said removing is performed by applying a projection P to the supervectors, where P is computed using the equation
P=I−VV^{T},
where:
V denotes a matrix created by stacking some of the eigenvectors,
I denotes the identity matrix, and
V^{T} denotes the transposed matrix of V.

3. The method of claim 1, wherein said number of highest value eigenvalues is a predefined number.

4. The method of claim 1, wherein said number of highest value eigenvalues is automatically computed by iteratively removing eigenvectors according to the highest unremoved eigenvalue, until a threshold value of a speaker score difference is reached, wherein said speaker score difference is the absolute value of the difference between a known-speaker score and an imposter score.

5. (canceled)

6. The method of claim 1, wherein said stabilized speaker recognition scores are normalized by setting the mean of the stabilized speaker recognition scores to a value of zero and the variance of the stabilized speaker recognition scores to a value of one.

7. The method of claim 1, wherein said removing comprises a transformation of the supervectors to remove a variation of the supervectors associated with the corresponding eigenvectors.

8. A computer program product for stabilizing speaker recognition score normalization parameters, the computer program product comprising a non-transitory computer-readable storage medium having program code embodied therewith, the program code executable by at least one hardware processor to:
apply Gaussian Mixture Model analysis to enrollment data acquired by a microphone of a computerized speaker recognition system, to obtain supervectors that are representative of multiple speech signal parameters contained in the enrollment data;
perform principal component analysis of a total variability covariance matrix of said supervectors, thereby producing eigenvalues and eigenvectors of said to total variability covariance matrix;
remove the eigenvectors of a number of highest value eigenvalues from the supervectors, thereby producing stabilized supervectors; and
send said stabilized supervectors to said computerized speaker recognition system;
compute, by said computerize speaker recognition system, stabilized score normalization parameters; and
perform speaker recognition by said computerized speaker recognition system, based on the score normalization parameters.

9. The computer program product of claim 8, wherein said number of highest value eigenvalues is a predefined number.

10. The computer program product of claim 8, wherein said number of highest value eigenvalues is automatically computed by iteratively removing eigenvectors according to the highest unremoved eigenvalue, until a threshold value of a speaker score difference is reached, wherein said speaker score difference is the absolute value of the difference between a known-speaker score and an imposter score.

11. (canceled)

12. The computer program product of claim 8, wherein said stabilized speaker recognition scores are normalized by setting the mean of the stabilized speaker recognition scores to a value of zero and the variance of the stabilized speaker recognition scores to a value of one.

13. The computer program product of claim 8, wherein said removing comprises a transformation of the supervectors to remove a variation of the supervectors associated with the corresponding eigenvectors.

14. A computerized system for stabilizing speaker recognition scores, comprising:
(a) a network adapter;
(b) a non-transitory computer-readable storage medium having stored thereon program code for:
receiving, using said network adapter, enrollment data from a computerized speaker recognition system that acquired the enrollment data by a microphone,
applying Gaussian Mixture Model analysis to the enrollment data to obtain supervectors that are representative of multiple speech signal parameters contained in the enrollment data,
performing principal component analysis of a total variability covariance matrix of said supervectors, thereby producing eigenvalues and eigenvectors of said total variability covariance matrix,
removing the eigenvectors of a number of highest value eigenvalues from the supervectors, thereby producing stabilized supervectors, and
sending said stabilized supervectors using said network adapter to said computerized speaker recognition system, to compute stabilized score normalization parameters; and
(c) at least one hardware processor configured to execute said program code.

15. The computerized system of claim 14, wherein said number of highest value eigenvalues is a predefined number.

16. The computerized system of claim 14, wherein said number of highest value eigenvalues is automatically computed by iteratively removing eigenvectors according to the highest unremoved eigenvalue, until a threshold value of a speaker score difference is reached, wherein said speaker score difference is the absolute value of the difference between a known-speaker score and an imposter score.

17. (canceled)

18. The computerized system of claim 14, wherein said stabilized speaker recognition scores are normalized by setting the mean of the stabilized speaker recognition scores to a value of zero and the variance of the stabilized speaker recognition scores to a value of one.

19. The computerized system of claim 14, wherein said removing comprises a transformation of the supervectors to remove a variation of the supervectors associated with the corresponding eigenvectors.

20. The computerized system of claim 14, wherein said computerized system comprises said speaker recognition system.
